(19) United States
(12) Patent Application Publication
(10) Pub. No.: US 2021/0150595 A1
(43) Pub. Date: May 20, 2021

(54) Experience Sensing Engine

(71) Applicant: Cleareye.ai, Inc., Irvine, CA (US)

(72) Inventors: Anoj Sivarama Pillai, Irvine, CA (US); Chandrasekhar Somasekhar, Thiruvananthapuram (IN)

(73) Assignee: Cleareye.ai, Inc., Irvine, CA (US)

(21) Appl. No.: 17/092,825

(22) Filed: Nov. 9, 2020

Related U.S. Application Data
(60) Provisional application No. 62/937,082, filed on Nov. 18, 2019.

(51) Int. Cl. G06Q 30/02

(52) U.S. Cl. CPC G06Q 30/0282

(57) ABSTRACT

A method, system and computer-readable medium a user's experience with an on-line interface is automatically scored by integrating one or more objective indicators (e.g., a base score, an award score, a sequence score, and a time score) with emotive telemetry from the user (e.g., based upon a machine-learning analysis of the user's emotive response) to produce an Experience Index measure.

### BACKGROUND

The effectiveness of any business process is measured by observing the two broad categories of signals viz. outcomes generated by the process and the inputs that went into the process including time & effort and costs. Moreover, a pivotal element for any process that involves human touchpoints is the emotive feedback from each touch point. Unlike automated processes, human actions trigger emotive outcomes that can vary across a wide spectrum even when the inputs and the outcomes remain the same. It is believed that any changes that can positively impact the emotive feedback while improving or providing the same outcomes and inputs will result in habit forming behaviors.

Understanding the emotive feedback of a user is a very manual process today. For example, an anthropologist may capture emotive feedback through user research that essentially involves observing users as they go through these interactions or interviewing them about their experience and applying tools like Zaltman metaphor elicitation technique (ZMET). This process is very time consuming, expensive and the results vary based on the skill level of the researcher. Hence, there is a need for computerized systems and methods capable of enabling the automation of capturing emotive feedback that previously could only be performed subjectively by humans.

### SUMMARY

The current disclosure is directed to computerized and/or computer-assisted systems and methods for capturing human experience touchpoints that include but are not limited to process telemetry, written/text interactions, speech & videos in a business process. The systems and methods compute an experience index that will measure the degree of aberrations in the overall experience. From that experience index, remedial activities can be performed or recommended.

It is an aspect of the current disclosure to provide a system and/or a method for automatically scoring a user's experience with an on-line interface. The method includes the steps of: (a) scoring objective indicators of a user's experience based upon one or more of: (B) a base score calculated based upon the complexity of the desired transaction with the on-line interface, (A) an award score based upon a level of outcome achieved with the desired transaction, (S) a sequence score based upon the number of steps required to achieve an outcome, and (T) a time score based upon an amount of time spent on the on-line interface to achieve the outcome; (b) scoring (E) emotive telemetry from the user based upon a machine-learning analysis of the user's emotive response; and (c) integrating the one or more objective indicators (B), (A), (S) and/or (T) with the (E) emotive telemetry to produce an Experience Index measure. In a more detailed embodiment, the integrating step integrates all objective indicators (B), (A), (S) and (T) with the emotive telemetry (E) to produce the Experience Index Measure.

In a more detailed embodiment, the base score (B) is calculated based upon a plurality of the following: (I′) the number of information elements, (D′) the number of decision points, (E′) the number of effects or outcomes that may result from the action, (A′) the number of steps or actions performed by the user, and/or (S′) the number of additional users involved in the step. In a further detailed embodiment, the base score (B) is calculated based upon the following equation:

B=I′×Iw+D′×Dw+E′×Ew+A′×Aw+S′×Sw
where Iw, Dw, Ew, Aw and Sw are weights associated with each respective factor.

Alternatively, or in addition, the emotive telemetry (E) measures the level of satisfaction or frustration with the on-line interface. Alternatively, or in addition, the emotive telemetry (E) measurement applies Natural Language Understanding (NLU) to mine specific references to one or more experience touchpoints and associated sentiments from text and/or recorded speech via electronic and/or social network feedback or comments provided by users of the on-line interface. Alternatively, or in addition, the emotive telemetry (E) measurement applies supervised neural network analysis as part of mining specific references to one or more experience touchpoints and associated sentiments from electronic and/or social network feedback or comments provided by users of the on-line interface. In a further detailed embodiment, the supervised neural network analysis utilizes Recursive Neural Tensor Network (RNTN). Alternatively, or in addition, the emotive telemetry (E) measurement applies deep learning analysis of recorded speech to derive tonal sentiment classification based on pitch, timbre, loudness and/or vocal tone present in the recorded speech.

Alternatively, or in addition, the award score (A) is calculated based upon an exponential relation with the number of non-completions of expected outcomes. In a further detailed embodiment, the award score (A) is calculated based on the following equation:

F(x)=e^{xn}
where “n” is constant based upon the complexity of the desired transaction and “x” is the number of non-completions of expected outcomes.

Alternatively, or in addition, the time score (T) is computed as the average time in seconds taken by the user to complete the interaction. In a further detailed embodiment, the time score (T) is calculated using the following equation:

T=((|t−b|)/b)×100
where b is a minimum time expected to complete a task.

The above summary may present a simplified overview of some embodiments of the invention in order to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention. These drawings should not be construed as limiting the invention and are intended only to be illustrative.

FIG. 1 is a schematic view of an experience index measure system, one or more machine learning models, and one or more user devices consistent with embodiments of the invention.

FIG. 2 is a diagram illustrating production of an experience index measure according to an aspect of the application.

FIG. 3 illustrates an emotions and feeling wheel according to an aspect of the application.

FIG. 4 illustrates emotive vectors according to an aspect of the application.

FIG. 5 illustrates a block diagram of an exemplary computing system.

FIG. 6 is a flowchart illustrating a sequence of operations that can be performed by experience index measure system of FIG. 1 to produce an experience index measure according to an aspect of the application.

### DETAILED DESCRIPTION

Embodiments provide systems, methods, and computer program products for sensing and measuring emotive experience of users.

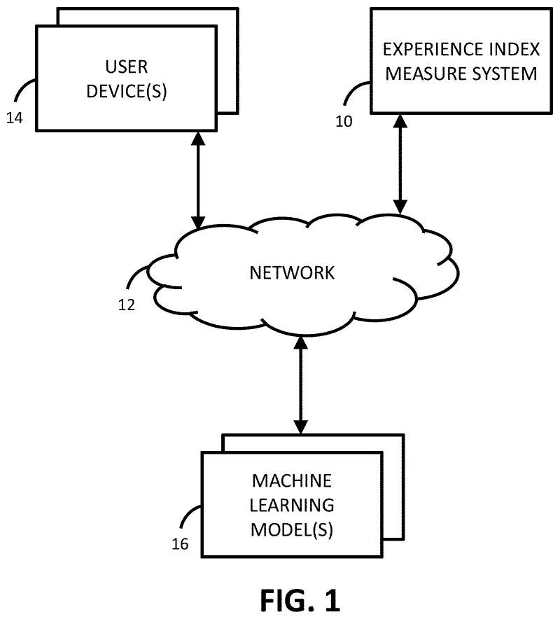

Turning now to the figures and particularly to FIG. 1, this figure provides a block diagram illustrating the one or more devices and/or systems consistent with embodiments of the invention. As shown in FIG. 1, an Experience Index Measure system 10 may be implemented as one or more servers. The Experience Index Measure system 10 may be connected to a communication network 12, where the communication network 12 may comprise the Internet, a local area network (LAN), a wide area network (WAN), a cellular voice/data network, one or more high speed bus connections, and/or other such types of communication networks. One or more user devices 14 may be connected to the communication network 12, such that a user may initialize a session with the Experience Index Measure system 10 to communicate human experience touchpoints and/or other such relevant data to the Experience Index Measure system 10. The user device 14 may be a personal computing device, tablet computer, thin client terminal, smart phone and/or other such computing device.

One or more machine learning models 16 may be connected to the communication network 12. The Experience Index Measure system 10 may initialize a session over the communication network 12 with each machine learning model 16. In some embodiments, a user may interface with the Experience Index Measure system 10 using the user device 14 in a reservation session to provide human experience touchpoints. In turn, the Experience Index Measure system 10 may interface with machine learning model 16 to compute an experience index, e.g., measuring the degree of aberrations in the overall experience. Furthermore, as will be appreciated, in some embodiments the Experience Index Measure system 10 may simulate alternate strategies to identify and recommend optimal remediations to improve the computed experience index.

As will be described in detail below, consistent with some embodiments, an interface may be generated by the Experience Index Measure system 10 such that a user may input information at a user device 14 that may be utilized to capture human experience touchpoints that may in turn be used to computes an experience index consistent with embodiments of the invention. To computes the experience index, the Experience Index Measure system 10 may interface with one or more machine learning models 16 to compute the experience index and measure the degree of aberrations in the overall experience. In some embodiments, the Experience Index Measure system 10 may measure the level of user aberration from an experience touch point.

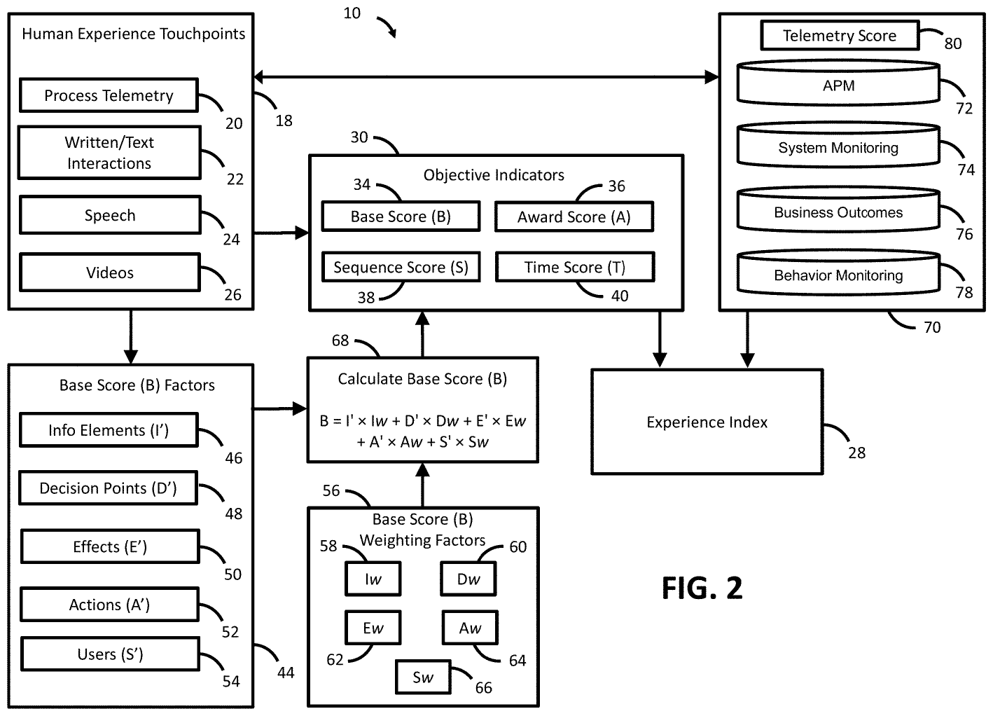

Turning now to FIG. 2, in an embodiment, the Experience Index Measure system 10 may capture human experience touchpoints 18. For example, the human experience touchpoints 18 may include process telemetry 20, written/text interactions 22, speech 24, and videos 26. For examples, the Experience Index Measure system 10 may capture human experience touchpoints 18 in a business process and computes an experience index that measures the degree of aberrations in the overall experience. In some examples, Experience Index Measure system 10 may include an extension to simulate alternate strategies to identify and recommend optimal remediations to improve the score. Moreover, an extension may baseline the score for standard interactions, e.g., customer onboarding, funds transfer, loan origination, etc.

According to some embodiments, the Experience Index Measure system 10 may offer a computational approach to sense and measure and the emotive experience of users from any process. For example, the Experience Index Measure system 10 may ingest multiple sensory signals pertaining to each touch point, and it may then classify and compute a score for each signal and aggregate the weighted index for each touch point and the overall process.

According to some embodiments, the Experience Index Measure system 10 may calculate an experience index 28 based on an aggregation multiple individual scores. For example, the experience index 28 may be calculated as an aggregation of objective indicators 30 and emotive telemetry (E) 32. The objective indicators 30 may include a base score (B) 34, an award score (A) 36, a sequence score (S) 38, and a time score (T) 40. Therefore, according to some embodiments, the experience index may be a function of B, E, A, S, and T, e.g., Experience Index=Function (B, E, A, S, T).

According to some embodiments, the base score (B) 34 may be computed (e.g., for every experience touchpoint) as a function of the complexity of an interaction. Accordingly, in some embodiments, every interaction may have a cost, e.g., no matter how simple and delightful.

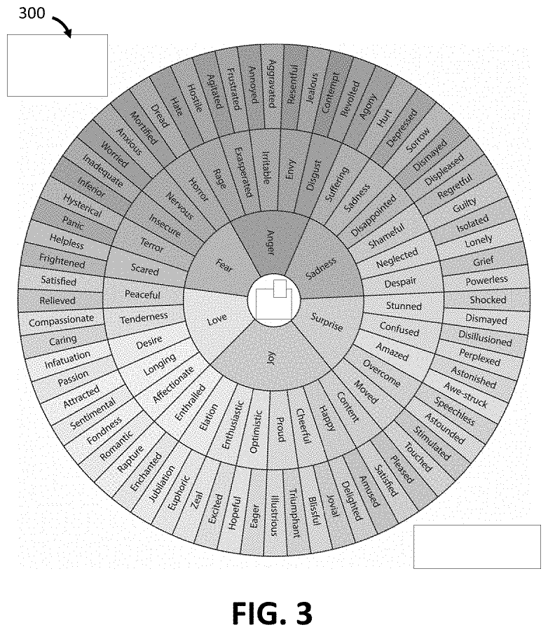

According to some embodiments, an emotive score (E) 42 may be measured as a projection of a degree of separation between an observed emotion and a desired emotion at any given experience touch point. For example, the emotions may be based on the emotions wheel 300 illustrated in FIG. 3 and may be measured as an absolute value (0-180). Moreover, in some embodiments, not all interactions are designed to create delight. For example, an interaction around a critical system alert may be desired to create a level of fear and anxiety prompting a user to take immediate action.

According to some embodiments, the award score (A) 36 is computed as a percentage based on a level of the business or a functional outcome that was desired out of an interaction. According to some embodiments, the sequence score (S) 38 may be computed as a function of the aggregated experience index, e.g., until the step prior to the current step and sequence number of the current step. Moreover, the sequence score (S) 38 may increase the costs as the number of steps increase. According to some embodiments, the time score (T) 40 may be computed as a function of time and effort spent by the user at the experience touch point.

According to some embodiments, base score (B) 34 may be calculated (e.g., in block 68) based on a number of base score (B) factors 44. For example, base score(B) factors 44 may include information elements (I′) 46 (e.g., a number of information elements on a screen or graphic user interface), decision points (D′) 48 (e.g., a number of decision points that a user encounters), effects (E′) 50 (e.g., a count of the effects or outcomes that may result from an action), actions (A′) 52 (e.g., steps or actions performed by a user), or users (S′) 54 (e.g., a number of additional users involved in a step).

Moreover, one or more base score (B) weighting factors 56 may be applied to each base score (B) factor 44. For example, base score (B) weighting factors 56 may include an information elements weighting factor (Iw) 58, a decision points weighting factor (Dw) 60, an effects weighting factor (Ew) 62, an actions weighting factor (Aw) 64, or a users weighting factor (Sw) 66.

In some embodiments, the Experience Index Measure system 10 may start with the base score (B) weighting factors 56 for each action. For example, the following values may be attached to each of the base score (B) weighting factors 56:

| | |
|---|---|
| Iw | 05 |
| Dw | 10 |
| Ew | 20 |
| Aw | 15 |
| Sw | 25 |

According to some embodiments, the Experience Index Measure system 10 may calculate base score (B) 34 (e.g., at block 68) through a summation of the products of each base score (B) factor 44 and the corresponding base score (B) weighting factors 56. For example, the base score (B) factor may be calculated according to the following equation:

B=I′×Iw+D′×Dw+E′×Ew+A′×Aw+S′×Sw

According to some embodiments, the system may apply a learning system to refine the base score (B) weighting factors 56. For example, an ongoing user research survey may collect inputs from users based on a scale of 1 to 10, e.g., representing an overall complexity of an interaction. Thus, according to some embodiments, domain and application specific biases may be factored into the Experience Index Measure system 10.

In some embodiments, an example experience score may involve a money transfer action. For example, the money transfer action may require a user to pick source and recipient accounts, review the balance in the source account, enter the amount to be transferred, initiate the transfer, etc. Moreover, the process may require the user to validate a transfer policy or transfer limits, choose a transfer speed, accept any fees involved, etc. Final outcomes of the money transfer action may include a successful transfer or a failure (e.g., with a reason). Example values of the objective indicators (30) may include:
I=3, D=3, E=2, A=7, S=0

Therefore, an example calculation of the base score *B) 34 (e.g., in accordance with block 68) may be as follows:

Base Score=3×05+3×10+2×20+7×15+0×25=15+30+40+105+0=190

According to some embodiments, the Experience Index 28 of a process may be computed as a simple aggregation of the individual experience touch points. For example, all experience scores may be collected on a scale of 0-100, where zero is a perfect score and a score of 100 indicates the user is unable to complete the transaction, act, objective, etc.

According to some embodiments, the Experience Index Measure system 10 may use a number of different techniques to capture and measure emotive signals from users (e.g., to calculate telemetry score 80). In some embodiments, the Experience Index Measure system 10 may utilize process telemetry 20 to ingest telemetry data 70 from application performance management (APM) 72, System Monitoring 74, Business outcomes 76, and user behavior monitoring tools 78, e.g., to create a time series correlation between an experience touch point and the system state at the instant of interaction.

According to some embodiments, the system monitoring 74 may primarily measure the health of the system at a point of interaction. According to some embodiments, a system performance baseline may be established at the beginning of an engagement with response times and system reliability as the primary measures. Moreover, secondary measures (e.g., accuracy and throughput) may be applied, for example, in specific types of tasks.

In some embodiments, the telemetry score 80 may measure the level of satisfaction or frustration with a system. For example, a system achieving or exceeding a defined performance baseline at a point of interaction may return a score of 0. Moreover, any deviation from the performance baseline may be measured on a scale of 0 to 100, e.g., where 100 represents a worst possible experience and may force a user to abandon an action. Likewise, any system unavailability or reliability issues may spike the telemetry score 80 to 100.

According to some embodiments, the Experience Index Measure system 10 may ingest written/text interactions 20 (e.g., social feedback or comments received from users). For example, the Experience Index Measure system 10 may apply Natural Language Understanding (NLU) to mine comments to extract specific references to one or more experience touchpoints (e.g., corresponding to the associated sentiment). Moreover, the Experience Index Measure system 10 may apply supervised Work Embeddings for Sentiment Analysis. In some embodiments, the Experience Index Measure system 10 may use a recursive neural tensor network (RNTN) to learn the composability of text of varying lengths and performs classification in a supervised fashion.

In some embodiments, machine learning models 16 may be trained with labelled data generated by a team of experience researchers. Moreover, machine learning models 16 may include a supervised model, trained with experts to generate training data.

According to some embodiments, the Experience Index Measure system 10 may receive speech 24, e.g., speech or voice streams. For example, the Experience Index Measure system 10 may perform a speech to text conversion and apply a similar analysis as with written/text interactions 20, e.g., applying NLU to mine comments to extract specific references to one or more experience touchpoints, applying supervised Work Embeddings for Sentiment Analysis, or applying an RNTN to learn the composability of text of varying lengths and perform classification in a supervised fashion. In some embodiments, the Experience Index Measure system 10 may detect and correlate a tonal sentiment of the user to respective touchpoint references that are extracted using NLU. For example, the Experience Index Measure system 10 may apply a deep learning tonal sentiment classification model based on the pitch, timbre, loudness, and vocal tone of the conversation.

According to some embodiments, the Experience Index Measure system 10 may receive videos 26, e.g., visual feedback or video streams. In some embodiments, a visual engine may use camera(s) to observe users as they go through experience touchpoints and apply deep learning models to sense and classify the emotive cues from the users. For example, the video feedback may be processed and classified using a convolutional neural network (CNN) based supervised neural network, e.g., trained with granular training data provided by user experience researchers.

According to some embodiments, human experience touchpoints 18 and any other emotive factors may be selected or augmented based upon a specific scenario. For example, user device(s) 14 may include any number of sensors associated with human experience touchpoints 18, telemetry data 70, etc.

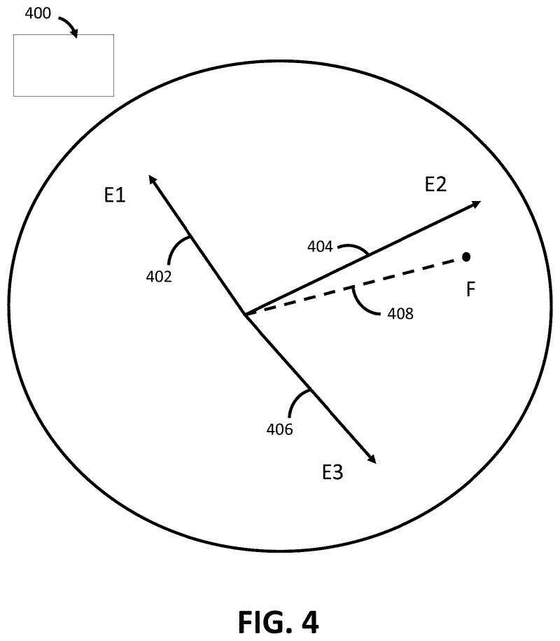

Turning now to FIG. 4, an example vector illustration 400 is provided. According to an example, emotive vectors E1 402, E2 404, and E3 406 have been obtained by the Experience Index Measure system 10, e.g., utilizing a combination of techniques as discussed above. According to some embodiments, a final emotive state (e.g., vector F 408) is derived from the emotive vectors (e.g., E1 402, E2 404, and E3 406).

According to some embodiments, when a given touchpoint has more than one emotive score present, the Experience Index Measure system 10 may use a composite normalization algorithm to derive a final emotive state.

According to some embodiments, the Experience Index Measure system 10 may compute an award score (A) 36 on a scale of 0 to 100, e.g., with 0 representing that the system achieved or exceeded all expected outcomes and 100 being none of the outcomes were achieved. For example, all partial completions may be awarded a score based on a preconfigured scaled defined by an experience benchmarking team. Accordingly, a higher score may represent a lower experience.

According to some embodiments, the Experience Index Measure system 10 may calculate a sequence score (S) 38 using an exponential function. For example,

F(x)=e^{xn}
where e=2.718281828459045 and n=a Scale Constant of 1-5 (e.g., chosen based on a complexity of the transaction).

For example, a bank loan (e.g., very complex) may be scored a 1, while a simple bank transaction may be scored a 4 or 5. The exponential nature of the Sequence Score (S) 38 may be based on an understanding that, as the number of steps grow, positive effect diminishes, and negative response increases exponentially.

According to some embodiments, the Experience Index Measure system 10 may compute a time score (T) 40 as an average time in seconds taken by the user to complete the interaction. For example:

T=((|t−b|)/b)×100
where b is the absolute minimum time expected to complete a task.

For the initial models b will be set to 10 seconds or less (e.g., if the task takes ten seconds or less the score T will be zero).

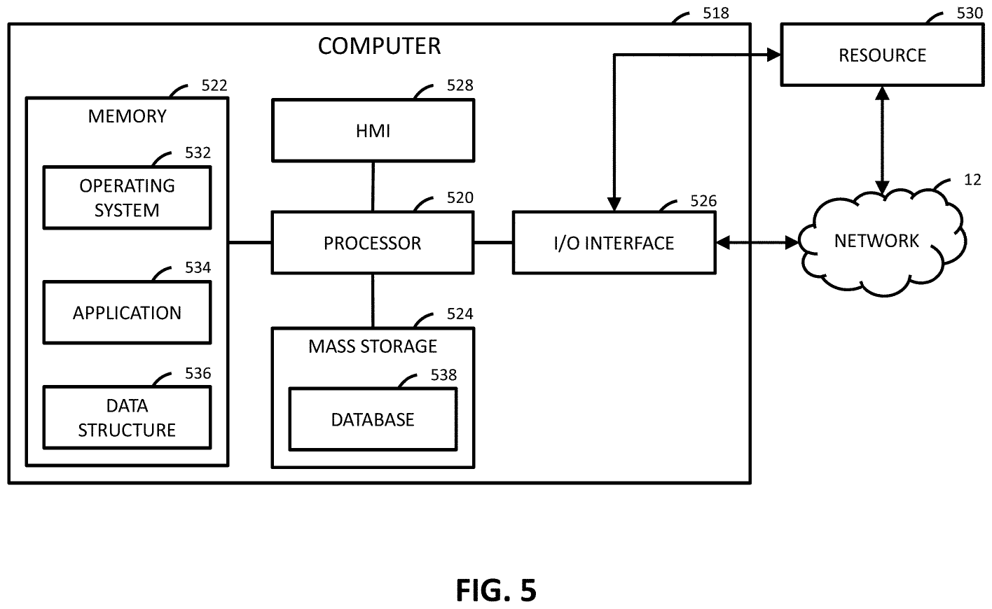

With reference to FIG. 5, the Experience Index Measure system 10 may be implemented on one or more computer devices or systems, such as exemplary computer system 518. The computer system 518 may include a processor 520, a memory 522, a mass storage memory device 524, an input/output (I/O) interface 526, and a Human Machine Interface (HMI) 528. The computer system 518 may also be operatively coupled to one or more external resources 530 via the communication network 12 or I/O interface 526. External resources 530 may include, but are not limited to, servers, databases, mass storage devices, peripheral devices, cloud-based network services, or any other suitable computer resource that may be used by the computer system 518.

The processor 520 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 522. The memory 522 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 24 may include data storage devices such as a hard drive, optical drive, tape drive, non-volatile solid state device, or any other device capable of storing information.

The processor 520 may operate under the control of an operating system 532 that resides in the memory 522. The operating system 532 may manage computer resources so that computer program code embodied as one or more computer software applications, such as an application 534 residing in memory 522, may have instructions executed by the processor 520. In an alternative embodiment, the processor 520 may execute the application 534 directly, in which case the operating system 532 may be omitted. One or more data structures 536 may also reside in memory 522, and may be used by the processor 520, operating system 352, or application 534 to store or manipulate data.

The I/O interface 526 may provide a machine interface that operatively couples the processor 520 to other devices and systems, such as the communication network 12 or the one or more external resources 530. The application 534 may thereby work cooperatively with the communication network 12 or the external resources 530 by communicating via the I/O interface 526 to provide the various features, functions, applications, processes, or modules comprising embodiments of the invention. The application 534 may also have program code that is executed by the one or more external resources 530, or otherwise rely on functions or signals provided by other system or network components external to the computer system 518. Indeed, given the nearly endless hardware and software configurations possible, persons having ordinary skill in the art will understand that embodiments of the invention may include applications that are located externally to the computer system 18, distributed among multiple computers or other external resources 30, or provided by computing resources (hardware and software) that are provided as a service over the communication network 12, such as a cloud computing service.

The HMI 528 may be operatively coupled to the processor 520 of computer system 518 in a known manner to allow a user to interact directly with the computer system 518. The HMI 528 may include video or alphanumeric displays, a touch screen, a speaker, and any other suitable audio and visual indicators capable of providing data to the user. The HMI 528 may also include input devices and controls such as an alphanumeric keyboard, a pointing device, keypads, pushbuttons, control knobs, microphones, cameras, sensors, etc., capable of accepting commands or input from the user and transmitting the entered input to the processor 520.

A database 538 may reside on the mass storage memory device 524 and may be used to collect and organize data used by the various systems and modules described herein. The database 538 may include data and supporting data structures that store and organize the data. In particular, the database 538 may be arranged with any database organization or structure including, but not limited to, a relational database, a hierarchical database, a network database, or combinations thereof. A database management system in the form of a computer software application executing as instructions on the processor 520 may be used to access the information or data stored in records of the database 538 in response to a query, where a query may be dynamically determined and executed by the operating system 532, other applications 534, or one or more modules.

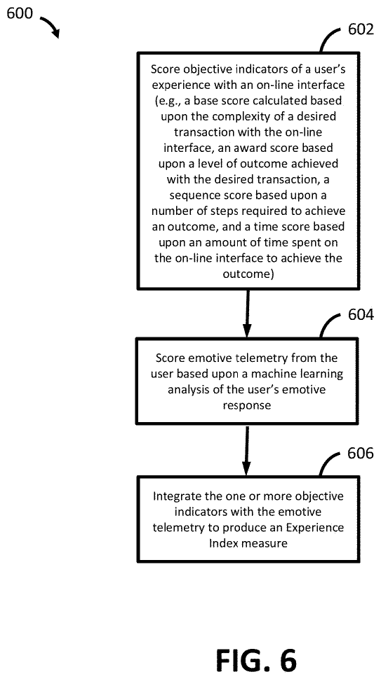

FIG. 6 illustrates an exemplary flowchart of a method 600 to produce an experience index measure according to an aspect of the application. The method 600 may be performed at a network device, UE, desktop, laptop, mobile device, server device, or by multiple devices in communication with one another. In some examples, the method 600 is performed by processing logic, including hardware, firmware, software, or a combination thereof. In some examples, the method 600 is performed by a processor executing code stored in a computer-readable medium (e.g., memory).

As shown in method 600, at block 602, the method 600 may score one or more objective indicators of a user's experience with an on-line interface. For example, the method 600 may calculate a base score (B) based upon the complexity of a desired transaction with the on-line interface. In some embodiments, the base score (B) may be calculated based upon one or more of the following factors: (I′) the number of information elements, (D′) the number of decision points, (E′) the number of effects or outcomes that may result from the action, (A′) the number of steps or actions performed by the user, and/or (S′) the number of additional users involved in the step. For example, the base score (B) may be calculated based upon the following equation:

B=I′×Iw+D′×Dw+E′×Ew+A′×Aw+S′×Sw
where Iw, Dw, Ew, Aw and Sw are weights associated with each respective factor.

As another example, the method 600 may calculate an award score (A) based upon a level of outcome achieved with the desired transaction. In some embodiments, the award score (A) may be calculated based upon an exponential relation with the number of non-completions of expected outcomes. For example, the award score (A) may be calculated based on the following equation:

F(x)=e^{xn}
where “n” is constant based upon the complexity of the desired transaction and “x” is the number of non-completions of expected outcomes.

In another example, the method 600 may calculate a sequence score (S) based upon a number of steps required to achieve an outcome.

In yet another example, the method 300 may calculate a time score (T) based upon an amount of time spent on the on-line interface to achieve the outcome. In some embodiments, the time score (T) may be computed as the average time in seconds taken by the user to complete the interaction. For example, the time score (T) may be calculated using the following equation:

T=((|t−b|)/b)×100
where b is a minimum time expected to complete a task.

As shown in method 600, at block 604, emotive telemetry (E) from the user may be scored based upon a machine learning analysis of the user's emotive response. For example, the emotive telemetry (E) may measure a level of satisfaction or frustration with the on-line interface. In some embodiments, the emotive telemetry (E) measurement may apply NLU to mine specific references to one or more experience touchpoints and associated sentiments from text and/or recorded speech via electronic and/or social network feedback or comments provided by users of the on-line interface. For example, the emotive telemetry (E) measurement may apply deep learning analysis of recorded speech to derive tonal sentiment classification based on pitch, timbre, loudness and/or vocal tone present in the recorded speech. Moreover, in some embodiments, the emotive telemetry (E) measurement may apply supervised neural network analysis (e.g., utilizing RNTN) as part of mining specific references to one or more experience touchpoints and associated sentiments from social network feedback or comments provided by users of the on-line interface.

As shown in method 600, at block 606, the one or more objective indicators may be integrated with the emotive telemetry to produce an Experience Index measure. In some embodiments, method 600 may integrate all objective indicators (e.g., base score, award score, sequence score, time score, etc.) with the emotive telemetry to produce the Experience Index Measure.

According to some embodiments, the Experience Index Measure system 10 may be fully automated and scalable. For example, one or more computational approaches described herein may be executed without any human intervention. Moreover, the Experience Index Measure system 10 may be scaled by adding additional hardware.

According to some embodiments, the Experience Index Measure system 10 may be consistent and standardized. For example, the Experience Index Measure system 10 may include computational models that apply standardized algorithms, e.g., with no possibility of introducing human bias based on expertise levels or personal preferences. Accordingly, scores provided by the Experience Index Measure system 10 may be consistent and durable.

According to some embodiments, the Experience Index Measure system 10 may utilize one or more simulations. For example, the Experience Index Measure system 10 may include a sensing engine that analyzes an impact of each factor that is influencing the experience index 28 and use simulations to identify and recommend the most optimal path for improving experience scores.

According to some embodiments, the Experience Index Measure system 10 may simulate and automate AB testing with advanced emulation models that mimic human personas. For example, a complex process may have multiple paths for traversing through. It may be possible for a simulation engine to simulate each of the various pathways and determine the most valuable pathway (e.g., the lowest Experience Index 28).

According to some embodiments, the Experience Index Measure system 10 may provide numerous commercial or competitive advantages. For example, the Experience Index Measure system 10 may be more cost effective than any alternative solutions, e.g., by eliminating dependencies on experts or through simple scalability. As another example, the Experience Index Measure system 10 may provide a shorter time to market than alternative solutions, e.g., a fully automated approach applied by the Experience Index Measure system 10 may provide near real time results, reducing the time to market from several weeks to days or hours. In another example, the Experience Index Measure system 10 may provide industry baseline scores, e.g., generating and monetizing industry benchmarks for user experience for standard business processes like customer onboarding, loan origination, etc.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a communication network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method for automatically scoring a user's experience with an on-line interface, comprising the steps of:
scoring objective indicators of a user's experience based upon one or more of: (B) a base score calculated based upon the complexity of the desired transaction with the on-line interface, (A) an award score based upon a level of outcome achieved with the desired transaction, (S) a sequence score based upon the number of steps required to achieve an outcome, and (T) a time score based upon an amount of time spent on the on-line interface to achieve the outcome;
scoring (E) emotive telemetry from the user based upon a machine-learning analysis of the user's emotive response; and
integrating the one or more objective indicators (B), (A), (S) and/or (T) with the (E) emotive telemetry to produce an Experience Index measure.

2. The method of claim 1, wherein the integrating step integrates all objective indicators (B), (A), (S) and (T) with the emotive telemetry (E) to produce the Experience Index Measure.

3. The method of claim 1, wherein the base score (B) is calculated based upon a plurality of the following: (I′) the number of information elements, (D′) the number of decision points, (E′) the number of effects or outcomes that may result from the action, (A′) the number of steps or actions performed by the user, and/or (S′) the number of additional users involved in the step.

4. The method of claim 3, wherein the base score (B) is calculated based upon the following equation:
B=I′×Iw+D′×Dw+E′×Ew+A′×Aw+S′×Sw
where Iw, Dw, Ew, Aw and Sw are weights associated with each respective factor.

5. The method of claim 1, wherein the emotive telemetry (E) measures the level of satisfaction or frustration with the on-line interface.

6. The method of claim 1, wherein the emotive telemetry (E) measurement applies Natural Language Understanding (NLU) to mine specific references to one or more experience touchpoints and associated sentiments from text and/or recorded speech via electronic and/or social network feedback or comments provided by users of the on-line interface.

7. The method of claim 1, wherein the emotive telemetry (E) measurement applies supervised neural network analysis as part of mining specific references to one or more experience touchpoints and associated sentiments from social network feedback or comments provided by users of the on-line interface.

8. The method of claim 7, wherein the supervised neural network analysis utilizes Recursive Neural Tensor Network (RNTN).

9. The method of claim 6 wherein the emotive telemetry (E) measurement applies deep learning analysis of recorded speech to derive tonal sentiment classification based on pitch, timbre, loudness and/or vocal tone present in the recorded speech.

10. The method of claim 1 wherein the award score (A) is calculated based upon an exponential relation with the number of non-completions of expected outcomes.

11. The method of claim 10, wherein the award score (A) is calculated based on the following equation:
F(x)=e^{xn}
where “n” is constant based upon the complexity of the desired transaction and “x” is the number of non-completions of expected outcomes.

12. The method of claims 1 wherein the time score (T) is computed as the average time in seconds taken by the user to complete the interaction.

13. The method of claim 12, wherein the time score (T) is calculated using the following equation:
T=((|t−b|)/b))×100
where b is a minimum time expected to complete a task.

14. A system comprising:
memory for storing computer instructions; and
one or more processors coupled with the memory, wherein the one or more processors, responsive to executing the computer instructions, performs operations comprising:
scoring objective indicators of a user's experience based upon one or more of: (B) a base score calculated based upon the complexity of the desired transaction with the on-line interface, (A) an award score based upon a level of outcome achieved with the desired transaction, (S) a sequence score based upon the number of steps required to achieve an outcome, and (T) a time score based upon an amount of time spent on the on-line interface to achieve the outcome;
scoring (E) emotive telemetry from the user based upon a machine-learning analysis of the user's emotive response; and
integrating the one or more objective indicators (B), (A), (S) and/or (T) with the (E) emotive telemetry to produce an Experience Index measure.

15. The system of claim 14, wherein the integrating step integrates all objective indicators (B), (A), (S) and (T) with the emotive telemetry (E) to produce the Experience Index Measure.

16. The system of claim 14, wherein the emotive telemetry (E) measures the level of satisfaction or frustration with the on-line interface.

17. The system of claim 14, wherein the emotive telemetry (E) measurement applies Natural Language Understanding (NLU) to mine specific references to one or more experience touchpoints and associated sentiments from text and/or recorded speech via electronic and/or social network feedback or comments provided by users of the on-line interface.

18. The system of claim 14, wherein the emotive telemetry (E) measurement applies supervised neural network analysis as part of mining specific references to one or more experience touchpoints and associated sentiments from social network feedback or comments provided by users of the on-line interface.

19. The system of claim 18, wherein the supervised neural network analysis utilizes Recursive Neural Tensor Network (RNTN).

20. A computer program product comprising:
a computer-readable storage medium; and
instructions stored on the computer-readable storage medium that, when executed by a processor, causes the processor to:
score objective indicators of a user's experience based upon one or more of: (B) a base score calculated based upon the complexity of the desired transaction with the on-line interface, (A) an award score based upon a level of outcome achieved with the desired transaction, (S) a sequence score based upon the number of steps required to achieve an outcome, and (T) a time score based upon an amount of time spent on the on-line interface to achieve the outcome;
score (E) emotive telemetry from the user based upon a machine-learning analysis of the user's emotive response; and
integrate the one or more objective indicators (B), (A), (S) and/or (T) with the (E) emotive telemetry to produce an Experience Index measure.
